(19) United States
(12) Patent Application Publication
(10) Pub. No.: US 2026/0252193 A1
(43) Pub. Date: Aug. 27, 2026

(54) MULTI-TONE STIMULUS CAPACITIVE SENSING

(71) Applicant: Microchip Technology Inc., Chandler, AZ (US)

(72) Inventor: Axel Heim, Munich (DE)

(73) Assignee: Microchip Technology Inc., Chandler, AZ (US)

(21) Appl. No.: 19/256,236

(22) Filed: Jul. 1, 2025

Related U.S. Application Data
(60) Provisional application No. 63/763,653, filed on Feb. 26, 2025.

(51) Int. Cl. G06F 3/041; G06F 3/044

(52) U.S. Cl. CPC G06F 3/0418; G06F 3/0446

(57) ABSTRACT

A capacitive touch sensing system with transmit electrodes and receive electrodes positioned to have mutual capacitances at electrode intersections called nodes. The capacitance at nodes deviate when touched. The system estimates a touch position by: generating a multi-tone drive signal for the drive electrode comprising a first drive sinusoidal signal having a first frequency and a second drive sinusoidal signal having a second frequency; driving the drive electrode with the multi-tone drive signal; sensing with the sense electrode a multi-tone-drive sense signal; frequency discriminating the multi-tone-drive sense signal to estimate a first multi-tone-drive sense signal characteristic for the first frequency and to estimate a second multi-tone-drive sense signal characteristic for the second frequency; combining the first multi-tone-drive sense signal characteristic and the second multi-tone-drive sense signal characteristic; and determining a deviation of the combined first and second multi-tone-drive sense signal characteristic.

### PRIORITY STATEMENT

This application claims priority to U.S. Provisional Patent Application No. 63/763,653, filed Feb. 26, 2025, the contents of which are hereby incorporated in their entirety for all purposes.

### TECHNICAL FIELD

The present disclosure relates to capacitive touch sensing systems, in particular, capacitive touch sensing systems that for a given drive signal range operate at multiple carrier frequencies simultaneously and weights touch measurement data for each carrier frequency afterwards, while preserving signal-to-noise ratio as for a single-carrier case with the same drive signal range.

### BACKGROUND

A typical approach for selecting a suitable carrier frequency or transmission channel in a data transmission system or sensing system such as, for example, a capacitive touch sensing system, is to perform regular or occasional noise measurements whose measurement data is evaluated and provides the decision base for selecting the carrier frequency for subsequent proximity or touch measurements. Such measurements can, for example, be scheduled within a measurement cycle. In fast-changing noise environments, a carrier frequency decision may be outdated before the subsequent touch measurement is completed. Ideally, the carrier frequency would be selected after the touch measurement, but of course that is not possible. Capacitive touch sensing systems sometimes experience noisy environments, such as when a universal serial bus (USB) charger produces an abruptly changing peak frequency. Capacitive touch sensing systems use automatic frequency adaptation (AFA) to select carrier frequency for next measurement based on noise measures from previous (auxiliary) measurements.

In the field of telecommunications, a diversity scheme refers to a method for improving the reliability of a message signal by using two or more communication channels with different characteristics. Diversity is mainly used in radio communication and is a common technique for combatting fading and co-channel interference and avoiding error bursts. It is based on the fact that individual channels experience fades and interference at different, random times, i.e., they are at least partly independent. Multiple versions of the same signal may be transmitted or received and combined in the receiver. Alternatively, a redundant forward error correction code may be added and different parts of the message are transmitted over different channels. Diversity techniques may exploit the multipath propagation, resulting in a diversity gain, often measured in decibels.

A known approach in the field of capacitive touch sensing is to employ a multitude of carrier frequencies, but individual transmit electrodes may use just one carrier frequency of the multitude of carrier frequencies, and the carrier frequencies can differ amongst the transmit electrodes. An advantage of this is that the transmit drive is simple because the stimulus of respective ones of transmit electrodes is a single tone, i.e., a sine wave. However, the signal-to-noise ratio (SNR) for electrode nodes whose transmit electrodes are driven with different carrier frequencies do differ, and can differ to such an extent that special handling is used to achieve spatial interpolation. For example, if the carrier frequency of a particular transmit electrode is polluted heavily with noise, then the SNR of electrode nodes associated with this transmit electrode is practically zero, and so is the information of this measurement, which makes it unusable. Further, a carrier frequency sweep may be used, but this involves averaging over frequency without exploiting information about which carriers are good (low noise) and which are not.

There is a need for capacitive touch sensing systems that provide reliable transmission signals without special handling for electrode nodes whose transmit electrodes have noisy carrier frequencies.

### SUMMARY

According to aspects, there is provided a method comprising: providing a capacitive sensing system comprising a drive electrode and a sense electrode, wherein a signal characteristic at the sense electrode deviates when an interfering object is proximate the sense electrode; and performing signal characteristic estimation by: generating a multi-tone drive signal for the drive electrode comprising a first drive sinusoidal signal having a first frequency and a second drive sinusoidal signal having a second frequency; driving the drive electrode with the multi-tone drive signal; sensing with the sense electrode a multi-tone-drive sense signal, frequency discriminating the multi-tone-drive sense signal to estimate a first multi-tone-drive sense signal characteristic for the first frequency and to estimate a second multi-tone-drive sense signal characteristic for the second frequency; combining the first multi-tone-drive sense signal characteristic and the second multi-tone-drive sense signal characteristic; and determining a deviation of the combined first and second multi-tone-drive sense signal characteristic.

An aspect as in the preceding paragraph provides a method, comprising acquiring confidence values for the first and second frequencies by: driving the drive electrode with a constant drive signal; sensing with the sense electrode a constant-drive sense signal; frequency discriminating the constant-drive sense signal to estimate a first constant-drive signal characteristic for the first frequency and to estimate at second constant-drive signal characteristic for the second frequency; and estimating from the first constant-drive signal characteristic a first confidence value for the first frequency and estimating from the second constant-drive signal characteristic a second confidence value for the second frequency.

An aspect as in one of the preceding two paragraphs provides a method, wherein the drive electrode and the sense electrode are the same electrode.

An aspect as in one of the preceding three paragraphs provides a method, comprising providing a capacitive sensing system comprising a plurality of drive electrodes and the sense electrode positioned to have mutual capacitances between respective ones of the drive electrodes and the sense electrode at nodes, wherein a signal characteristic at the sense electrode deviates when an interfering object is proximate.

An aspect as in one of the preceding four paragraphs provides a method, wherein combining the first and second multi-tone-drive sense signal characteristics comprises: equal-gain combining, selection combining, or weighted least squares combining.

An aspect as in one of the preceding five paragraphs provides a method, wherein the first multi-tone-drive sense signal characteristic for the first frequency is a first amplitude, the second multi-tone-drive sense signal characteristic for the second frequency is a second amplitude, and wherein first and second amplitudes are within 5% of each other.

An aspect as in one of the preceding six paragraphs provides a method, wherein the first and second drive sinusoidal signals have amplitudes within 10% of a largest amplitude of the first and second drive sinusoidal signals.

An aspect as in one of the preceding seven paragraphs provides a method, wherein generating the multi-tone drive signal is for respective ones of the plurality of drive electrodes; and driving the drive electrode with the multi-tone drive signal comprises driving respective ones of the plurality of drive electrodes at different start phases for respective ones of the drive electrodes.

An aspect as in one of the preceding eight paragraphs provides a method, wherein the multi-tone drive signal comprises a third drive sinusoidal signal having a third frequency, wherein the first drive sinusoidal signal has the first frequency and a first start phase, wherein the second drive sinusoidal signal has the second frequency that is two times the first frequency and a second start phase in phase with the first start phase or shifted by pi radian relative to the first start phase, and wherein the third drive sinusoidal signal has a third frequency that is three times the first frequency and a third start phase that is pi radian out of phase with the first start phase.

An aspect as in one of the preceding nine paragraphs provides a method, wherein the multi-tone drive signal comprises a rectangular pulse train having a fundamental frequency and at least a third harmonic frequency.

An aspect as in one of the preceding ten paragraphs provides a method, comprising scanning for noise at a plurality of frequencies prior to generating a multi-tone drive signal.

An aspect as in one of the preceding eleven paragraphs provides a method, comprising: providing a capacitive sensing system comprising a plurality of sense electrodes positioned to have mutual capacitances between respective ones of the drive electrodes and the sense electrode at nodes, wherein a mutual capacitance at a node deviates when an interfering object is proximate; and decoding the multi-tone sense signal for respective ones of the sense electrodes.

According to aspects, there is provided a system comprising: a capacitive touch sensing system comprising a drive electrode and a sense electrode, wherein a signal characteristic at the sense electrode deviates when an interfering object is proximate the sense electrode; a processor; and a machine readable storage medium storing instructions, which when executed by the processor, cause the system to: generate a multi-tone drive signal for the drive electrode comprising a first drive sinusoidal signal having a first frequency and a second drive sinusoidal signal having a second frequency; drive the drive electrode with the multi-tone drive signal; sense with the sense electrode a multi-tone-drive sense signal comprising a first sense sinusoidal signal having the first frequency and a second sense sinusoidal signal having the second frequency, frequency discriminate the multi-tone-drive sense signal to estimate a first multi-tone-drive sense signal characteristic for the first frequency and to estimate a second multi-tone-drive sense signal characteristic for the second frequency; and combine the first multi-tone-drive sense signal characteristic and the second multi-tone-drive sense signal characteristic; and determine a deviation of the combined first and second multi-tone-drive sense signal characteristic.

An aspect as in the preceding paragraph provides a system, comprising instructions, which when executed by the processor, cause the system to acquire confidence values for the first and second frequencies by: driving the drive electrode with a constant drive signal; sensing with the sense electrode a constant-drive sense signal; frequency discriminating the constant-drive sense signal to estimate a first constant-drive signal characteristic for the first frequency and to estimate at second constant-drive signal characteristic for the second frequency; and estimating from the first constant-drive signal characteristic a first confidence value for the first frequency and estimating from the second constant-drive signal characteristic a second confidence value for the second frequency.

An aspect as in one of the preceding two paragraphs provides a system, wherein the drive electrode and the sense electrode are the same electrode.

An aspect as in one of the preceding three paragraphs provides a system, wherein the instructions, which when executed by the processor, cause the system to combine the first and second multi-tone-drive sense signal characteristics by equal-gain combining, selection combining, or weighted least squares combining.

An aspect as in one of the preceding four paragraphs provides a system, wherein the first multi-tone-drive sense signal characteristic for the first frequency is a first amplitude, the second multi-tone-drive sense signal characteristic for the second frequency is a second amplitude, and wherein first and second amplitudes are within 5% of each other, wherein the multi-tone drive signal comprises a third drive sinusoidal signal having a third frequency, wherein the first, second, and third drive sinusoidal signals have amplitudes within 10% of a largest amplitude of the first, second, and third drive sinusoidal signals, wherein the first drive sinusoidal signal has the first frequency and a first start phase, wherein the second drive sinusoidal signal has the second frequency that is two times the first frequency and a second start phase in phase with the first start phase or shifted by pi radian relative to the first start phase, and wherein the third drive sinusoidal signal has a third frequency that is three times the first frequency and a third start phase that is pi radian out of phase with the first start phase.

An aspect as in one of the preceding five paragraphs provides a system, wherein the multi-tone drive signal comprises a rectangular pulse train having a fundamental frequency and at least a third harmonic frequency.

An aspect as in one of the preceding six paragraphs provides a system, wherein the instructions, which when executed by the processor, cause the system to: scan for noise at a plurality of frequencies prior to generating a multi-tone drive signal.

An aspect as in one of the preceding seven paragraphs provides a system, comprising: a plurality of drive electrodes; and a plurality of sense electrodes positioned to have mutual capacitances between respective ones of the drive electrodes and respective ones of the sense electrodes at nodes, wherein mutual capacitances at nodes deviate when an interfering object is proximate, wherein the instructions, which when executed by the processor, cause the system to: decode the multi-tone sense signal for respective ones of the sense electrodes.

### BRIEF DESCRIPTION OF THE DRAWINGS

A more complete understanding of the disclosure and the advantages thereof may be acquired by referring to the following description, taken in conjunction with the accompanying drawings and wherein:

FIG. 1 shows a capacitive touch sensing system with frequency diversity (multi-tone-driver signal).

FIG. 2A shows a capacitive touch sensing system with frequency diversity (multi-tone-driver signal), wherein noise is indicated on two of the three carrier frequencies.

FIG. 2B shows one touch level value per electrode node for three carrier frequencies with a) low external noise (Row 1), b) stronger external noise for the highest frequency (Row 2), and c) stronger external noise for the two higher frequencies as shown in FIG. 2A.

FIG. 3 shows a graph of constituent signals of a multi-tone-driver signal.

FIG. 4 shows formulas to produce a single-tone transmit driver or stimulus signal and a resulting waveform.

FIG. 5 shows formulas to produce a diversity (multi-tone) transmit driver or stimulus signal and a resulting waveform.

FIG. 6 shows formulas to produce a diversity (multi-tone) transmit driver or stimulus signal and a resulting waveform.

FIG. 7 shows the first three non-zero harmonics (1^{st}, 3^{rd}, 5^{th}) of a rectangular pulse train signal, indicating frequency, amplitude and phase of these harmonics.

FIG. 8A shows a plot of the receive signal given a rectangular pulse-train stimulus.

FIG. 8B shows a spectrum plot of the receive signal plot of FIG. 8A, where signal energies at the fundamental frequency as well as its 3rd harmonic and 5th harmonic are distinctively visible.

FIG. 9A illustrates an approach for noise scans in the context of touch sensing, wherein noise levels are used for touch scan measurement data of a later cycle.

FIG. 9B illustrates a new approach for noise scans in the context of touch sensing, wherein noise levels may be used for weighting touch data for different tone frequencies with the touch data computed from the same cycle's touch scan measurement data.

FIG. 9C illustrates a new approach for noise scans in the context of touch scans, wherein merge noise levels may be computed from noise scans before and after a touch scan for weighting touch data for different tone frequencies computed from the encapsulated touch scan's measurement data.

FIG. 9D illustrates a new approach for noise scans in the context of touch scans, wherein noise levels may be used for weighting touch data for different tone frequencies with the touch data computed from preceding (new) or subsequent partial touch scan's measurement data.

FIG. 9E illustrates a new approach for noise scans in the context of touch scans, wherein touch scan measurement data may be used without an explicit noise scan.

FIG. 10 shows a method for operating a capacitive touch sensing system with multiple carriers simultaneously and makes a “best carrier” decision afterwards, while preserving SNR as for a single-carrier case.

The drawings accompanying and forming part of this specification are included to depict certain aspects of the disclosure. The reference number for any illustrated element that appears in multiple different figures has the same meaning across the multiple figures, and the mention or discussion herein of any illustrated element in the context of any particular figure also applies to each other figure, if any, in which that same illustrated element is shown. The features illustrated in the drawings are not necessarily drawn to scale. It should be noted that the features illustrated in the drawings are not necessarily drawn to scale.

### DESCRIPTION

According to aspects, there is provided a capacitive touch sensing system that for a given drive signal range operates multiple carriers simultaneously and weights touch measurement data for each carrier frequency afterwards, while preserving SNR as for a single-carrier case with the same drive signal range.

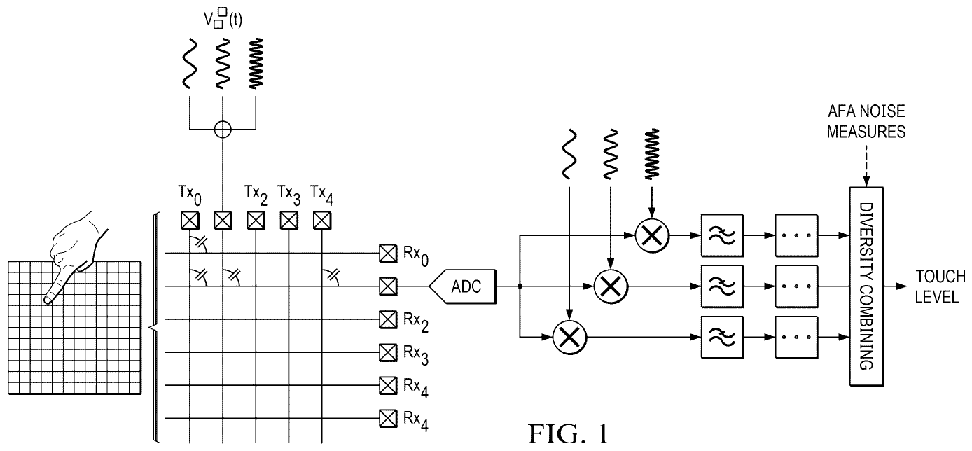

FIG. 1 shows a capacitive touch sensing system with a multi-tone-driver signal being the sum of three single-tone signals. That is, it is employing frequency diversity. The frequency of each of the three single-tone signals is referred to as carrier frequency. The drive signal from each Tx electrode (Tx₀-Tx₄) is coupled capacitively into each Rx electrode (Rx₀-Rx₅). For each Rx electrode, the receive signal is demodulated for all three carrier frequencies, and one touch level value per Tx-Rx electrode node and carrier frequency is computed. Upon proximity or touch of an object, a touch level value may change. The quality input for diversity combining may be the same as is used for automatic frequency adaptation (AFA), i.e., noise power estimates computed from noise measurements, but now may apply to current measurement data.

The stimuli for all Tx electrodes may be equal but possibly for their amplitudes, to allow for time division multiplexing (TDM), or for their phase, to allow for code division multiplex (CDM) decoding and quadrature code division multiplex (QCDM) decoding, and hence a single global spectral noise analysis may be used with no special handling for electrode nodes whose Tx electrodes have used ‘good’ or ‘bad’ carrier frequencies. Emissions may go down, but the emissions are now on or around a multitude of (constituent) carrier frequencies.

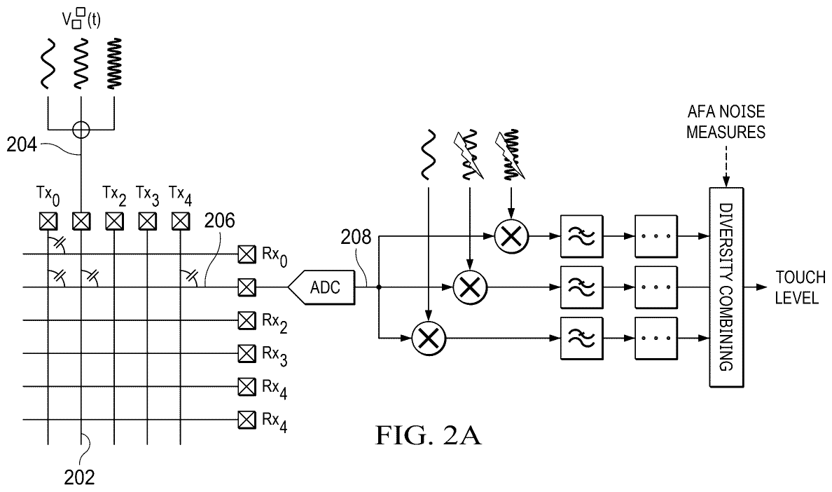

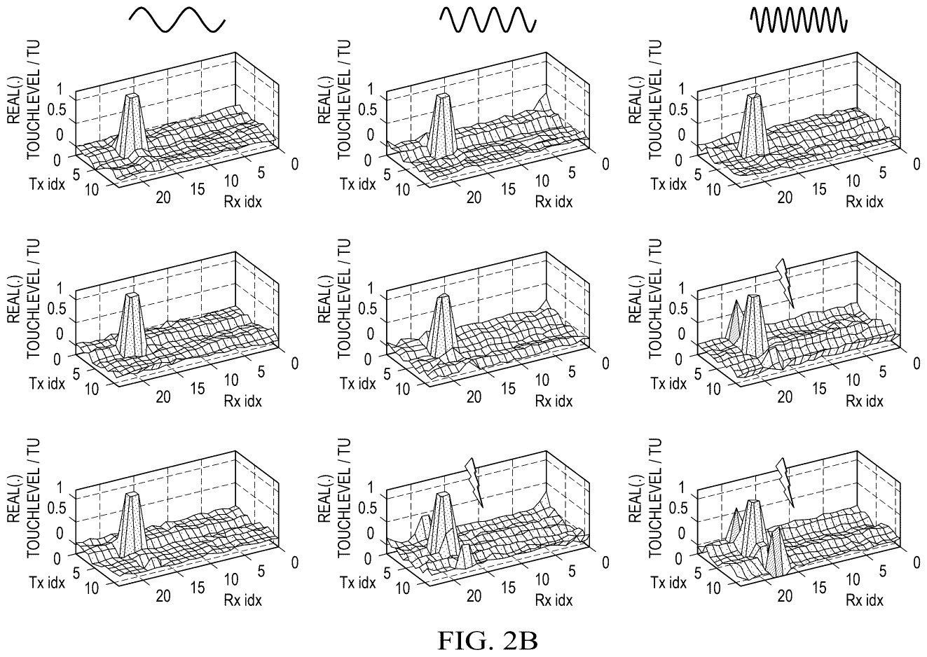

FIG. 2A shows a capacitive touch sensing system with frequency diversity (multi-tone-driver signal), wherein noise is indicated on two of the three frequency carriers. The receive signal is demodulated for the three carrier frequencies, one touch level is computed for each Tx-Rx electrode node and each of the carrier frequencies, and diversity combining is employed to provide one touch level value per electrode node. In particular, a multi-tone drive signal 204 for the drive electrode 202 may be generated comprising a first drive sinusoidal signal having a first frequency, a second drive sinusoidal signal having a second frequency, and a third drive sinusoidal signal having a third frequency. The drive electrode 202 may be driven with the multi-tone drive signal 204. A sense electrode 206 may sense a multi-tone-drive sense signal 208 comprising a first sense sinusoidal signal having the first frequency, a second sense sinusoidal signal having the second frequency, and a third sense sinusoidal signal having the third frequency. The multi-tone-drive sense signal 208 may be frequency discriminated to estimate: a first multi-tone-drive sense signal characteristic for the first frequency, a second multi-tone-drive sense signal characteristic for the second frequency, and a third multi-tone-drive sense signal characteristic for the third frequency. The first multi-tone-drive sense signal characteristic may be combined with the second multi-tone-drive sense signal characteristic. A deviation of the combined first and second multi-tone-drive sense signal characteristic may then be determined. FIG. 2B shows one touch level value per electrode node for the three frequency carriers shown in FIG. 2A.

The diversity combining, i.e., combining multi-tone-drive sense signal characteristics, may be: equal-gain combining; selection combining; or weighted least squares combining. For equal gain combining, the signals are summed and then divided by the number of signals to obtain an average. For selection combining, one is selected. For weighted least squares, the matrices are weighted with their qualities. For CDM, diversity combining may be done after de-spreading, because for de-spreading the signal level of all chips should be equal.

For weighted least squares combining, the respective ones of the matrices are weighted with its quality according to the following equation.

$${δ}_{tot} = \frac{1}{\frac{1}{{η}_{0}} + \frac{1}{{η}_{1}} + \frac{1}{{η}_{2}}} \cdot ( \frac{{δ}_{0}}{{η}_{0}} + \frac{{δ}_{1}}{{η}_{1}} + \frac{{δ}_{2}}{{η}_{2}} )$$

where ηᵥ is a noise power measure for carrier v=0, 1, 2 . . . n; and where δᵥ is the touch level for carrier v.

According to aspects, there is provided a method to: a) employ frequency diversity, i.e., to drive respective ones of Tx electrodes with a stimulus signal being a weighted sum of multiple single-tone signals; b) diversity combining, for example, selection diversity, i.e., selecting the carrier frequency with the highest SNR, equal-gain combining or maximum-ratio combining; and c) select a stimulus signal, i.e., a set of frequencies with phase and amplitude such as to decrease the sum signal's swing while increasing the constituent signals' powers.

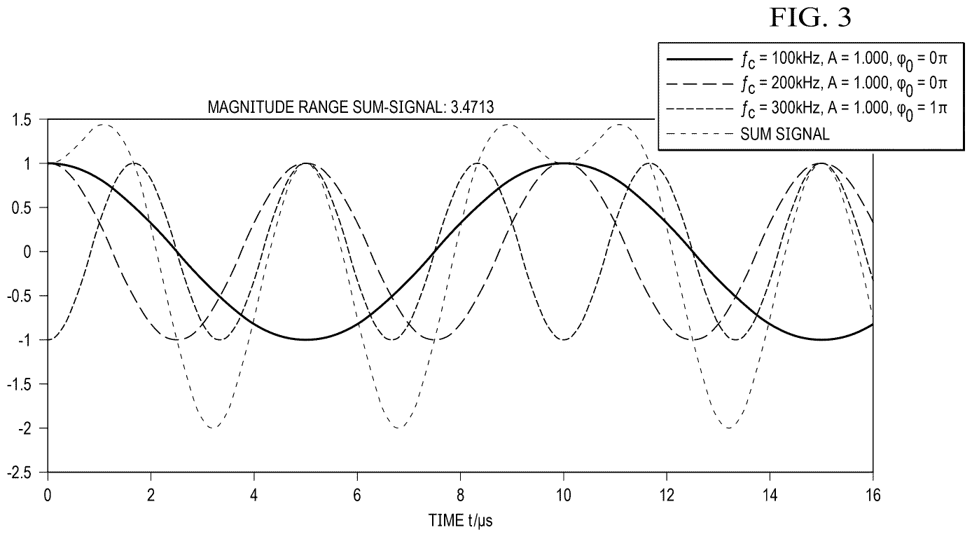

FIG. 3 shows a graph of constituent signals of a multi-tone-driver signal. Aspects provide for the weighting of each of the employed constituent signals' component in the received signal a posteriori, i.e., the choice or weighting can be made after the actual measurement. Using appropriate constituent signals, as shown in FIG. 3, with an unchanged signal swing the SNR as obtained for single-tone measurements can be preserved, while significantly improving noise robustness in the presence of injected or conducted noise with abruptly jumping noise frequencies. Hence, aspects allow systems to cope with noise of certain AC/DC power adapters (USB-Chargers) whose noise frequencies jump abruptly.

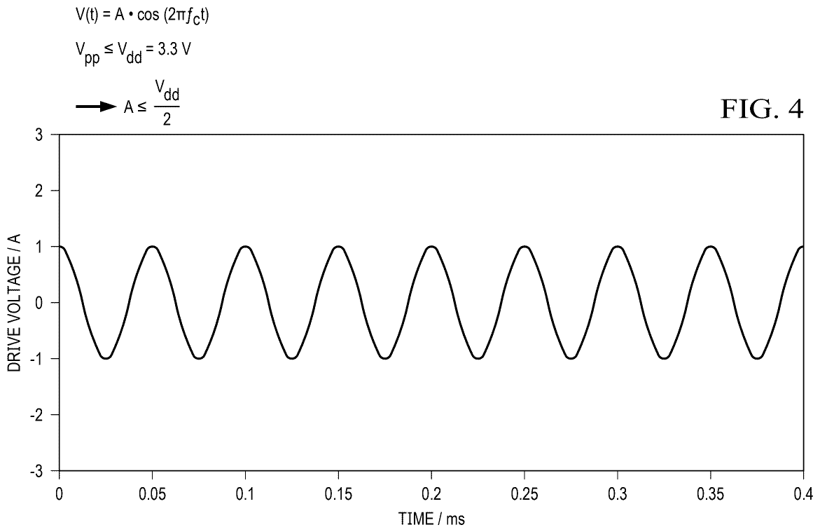

FIG. 4 shows formulas to produce a single-tone transmit driver or stimulus signal and a resulting waveform. The single-tone stimulus signal may be selected so as to comply with the usual limit of Tx signal range, for example, 0V to Vdd=3.3V.

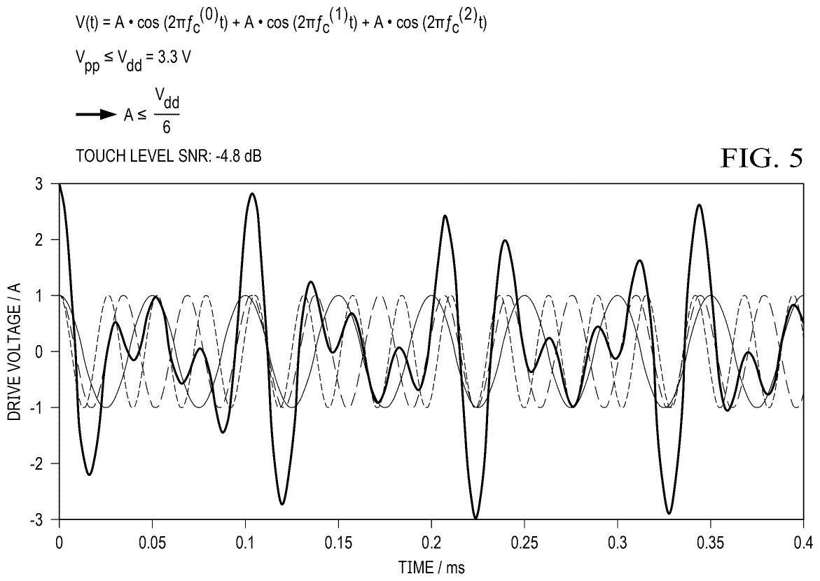

FIG. 5 shows formulas to produce a diversity (multi-tone) transmit driver or stimulus signal and a resulting waveform. The multi-tone stimulus signal may be selected so as to comply with the usual limit of Tx signal range, for example, 0V to Vdd=3.3V. While this diversity signal provides the ability to do diversity combining, it looses 4.8 dB in the touch level SNR.

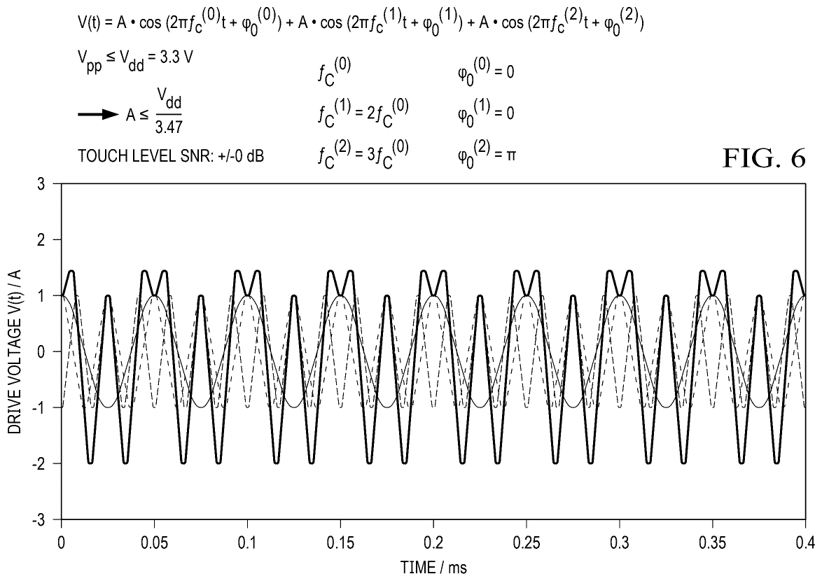

FIG. 6 shows formulas to produce a diversity (multi-tone) transmit driver or stimulus signal and a resulting waveform. The stimulus signal may be selected so as to comply with the usual limit of Tx signal range, for example, 0V to Vdd=3.3V. The frequencies of the three signals are set to 1, 2, and 3 times the frequency of the first constituent signal, respectively. The phases of the three signals are set to 0, 0, and I, respectively. This diversity signal provides the ability to do diversity combining, and it maintains the touch level SNR at approximately +/−0 dB.

Aspects allow the receive signal characteristics for each constituent signal's carrier frequency to be selected or weighted a posteriori, i.e., the choice of carrier frequency can be made after the actual measurement.

Using appropriate constituent signals, for example as shown in FIG. 3, with an unchanged drive signal swing the SNR as obtained for single-tone measurements can be preserved, while significantly improving noise robustness in the presence of injected or conducted noise with abruptly jumping noise frequencies.

### Example 1

For a stimulus signal with a signal swing significantly smaller than the sum of the constituent signals' swings (which is desired): Overlaying two (three) arbitrary tones with amplitude A=1 unit (peak-to-peak range: 2 units) yields a peak-to-peak range of 2*2=4 units (3*2=6 units), but with the three tones 100 kHz, 200 kHz and −300 kHz it yields a peak-to-peak swing of 3.47 units (instead of 6 units). See FIGS. 3 and 6.

Table 1 illustrates how-despite the Tx signal range limitations-SNR can be preserved for particular combinations of constituent signals as in the example of FIG. 3. When there is no (external) noise on any of the constituent carrier frequencies, the SNR may be equal to the case of single-tone stimulus. When one of the carrier frequencies is polluted and discarded, then the multi-tone stimulus approach suffers a SNR loss of 1.76 dB. For the single-tone approach, there may be a risk of hitting the (suddenly) polluted carrier frequency and end up with a completely information-less receive signal.

TABLE 1

| | constit. | | | |
|---|---|---|---|---|
| | ampl. | constit. range | Rx ampl. | Signal Dev. (SD) |
| single-tone stimulus | A | 2 · A | γ · A | δ · γ · A |
| N-tone stimulus (plain) | A · 1/N | 2 · A · 1/N | γ · A · 1/N | δ · γ · A · 1/N |
| 3-tone stim. (cf. Ex. 1) | A · 2/3.47 | 2 · A · 2/3.47 | γ · A · 2/3.47 | δ · γ · A · 2/3.47 |
| 3 of 3 constit. freq. used | | | | 3 · δ · γ · A · 2/3.47 |
| 2 of 3 constit. freq. used | | | | 2 · δ · γ · A · 2/3.47 |
| 1 of 3 constit. freq. used | | | | 1 · δ · γ · A · 2/3.47 |

| | Noise Variance | SNR |
|---|---|---|
| single-tone stimulus | σ² | (δ · γ · A)² / σ² = : SNR_{ref} |
| N-tone stimulus (plain) | N · σ² | (N · δ · γ · A · 1/N)² / N · σ² = 1/N · SNR_{ref} |
| 3-tone stim. (cf. Ex. 1) | | |
| 3 of 3 constit. freq. used | 3 · σ² | (3 · δ · γ · A · 2/3.47)² / 3 · σ² ≈ SNR_{ref} |
| 2 of 3 constit. freq. used | 2 · σ² | (2 · δ · γ · A · 2/3.47)² / 2 · σ² ≈ ⅔ · SNR_{ref} |
| 1 of 3 constit. freq. used | 1 · σ² | (1 · δ · γ · A · 2/3.47)² / 1 · σ² ≈ ⅓ · SNR_{ref} |

| | SNR Loss | |
|---|---|---|
| single-tone stimulus | | |
| N-tone stimulus (plain) | 10 log₁₀ N | |
| 3-tone stim. (cf. Ex. 1) | | |
| 3 of 3 constit. freq. used | 0 | dB |
| 2 of 3 constit. freq. used | 1.76 | dB |
| 1 of 3 constit. freq. used | 4.77 | dB |

σ²: (background) noise variance
γ: Tx-Rx carrier signal scaling factor
δ: signal deviation scaling factor

Rx Signal Processing: Increased complexity as demodulation, low-pass filtering and mutual-capacitance phasor equalization may be done for all constituent frequencies, which may be considered in the computation of the final output. This may be all constituent frequencies, as aspects may prefer maximum ratio combining (MRC).

### Example 2: “Rectangular Pulse-Train Stimulus”

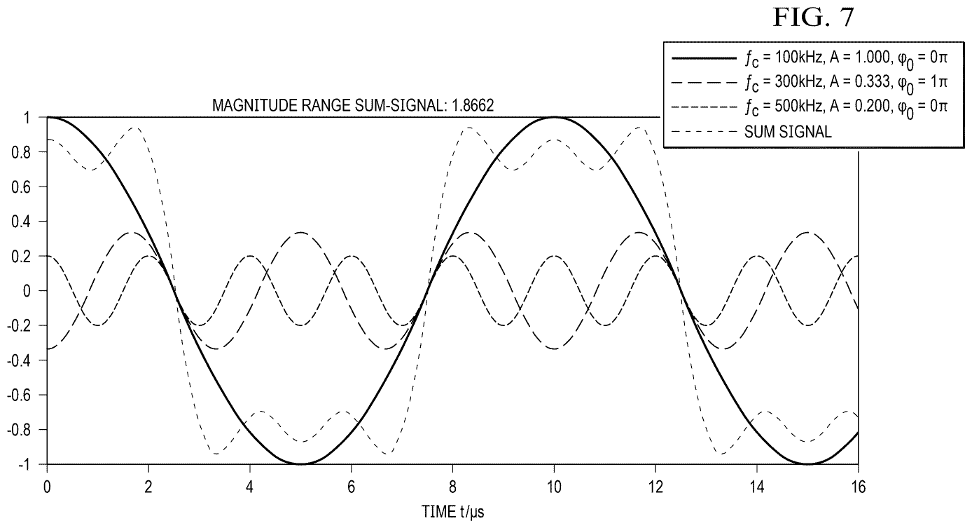

FIG. 7 shows the first three constituent signals of such rectangular signal, indicating frequency, amplitude and phase of the constituent signals. A rectangular pulse train also is a multi-tone signal, the tones being the fundamental frequency and its odd harmonics. The receive signal energy may be exploited from those frequencies—wherein it may be worthwhile to compute the few lower harmonics and not compute higher harmonics since the latter carry less energy.

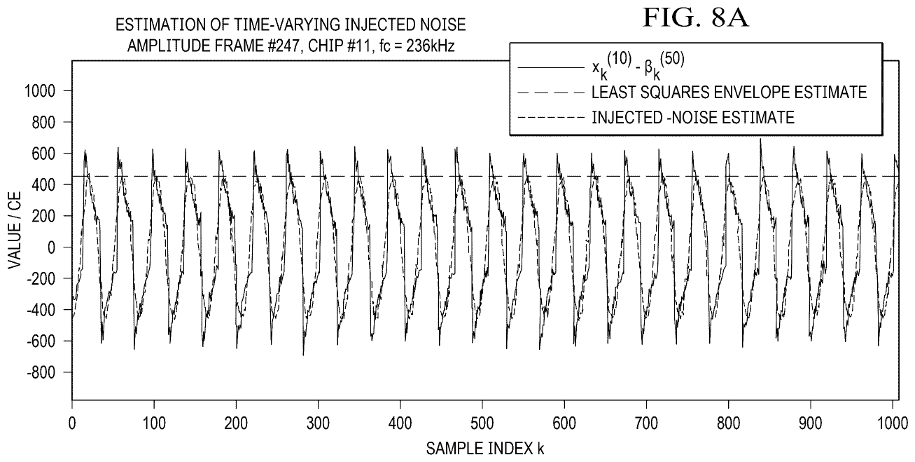

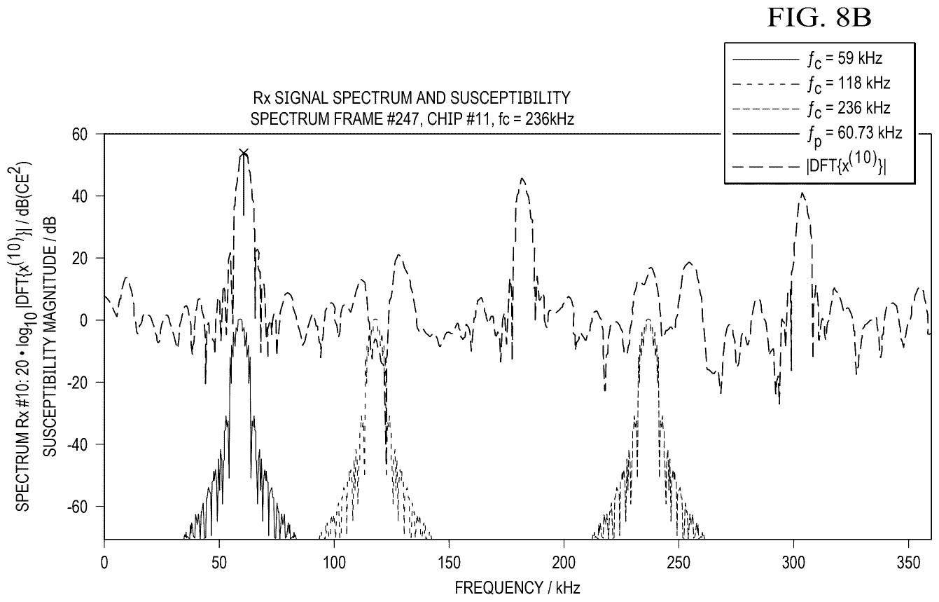

FIG. 8A shows a plot the receive signal given a rectangular pulse-train stimulus. FIG. 8B shows a spectrum plot of the receive signal plot of FIG. 8A, where signal energies at the fundamental frequency (60 kHz) as well as its 3rd harmonic (180 kHz) and 5th harmonic (300 kHz) are distinctively visible.

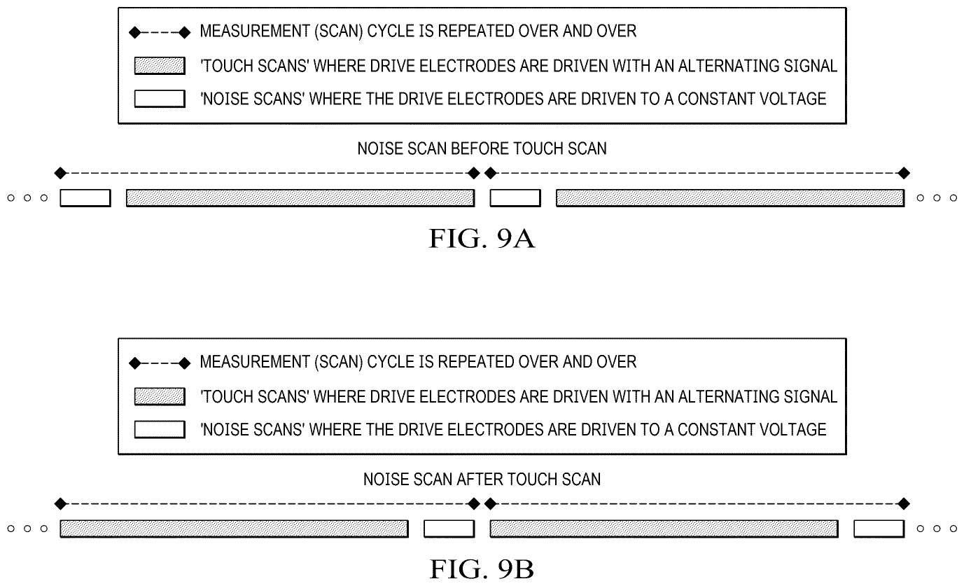

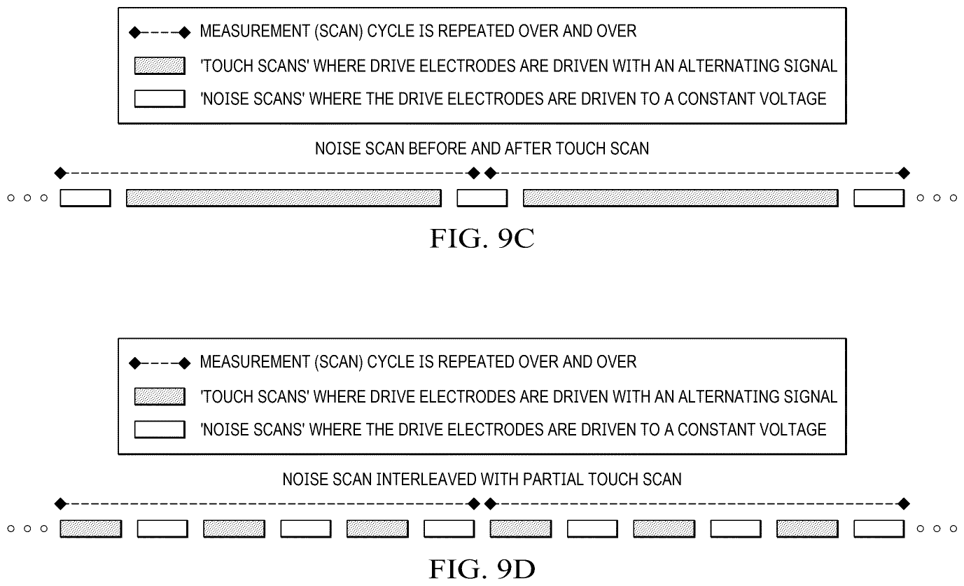

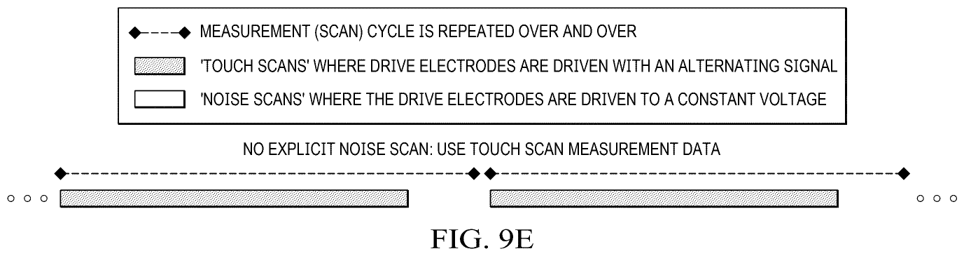

FIGS. 9A-9E show results for noise scans in the context of touch scans. Noise levels are computed from noise scan measurement data. Duration of noise scan is typically shorter than duration of touch scan.

FIG. 9A illustrates an approach for noise scans in the context of touch scans, wherein noise levels are used for touch scan data of a subsequent measurement, wherein a single carrier (drive) frequency is selected for a touch scan of the same or a subsequent measurement cycle(s). With reference to FIG. 9A, according to the approach, noise levels are used to determine touch scan drive frequency for current or a later measurement cycle.

FIG. 9B illustrates a new approach for noise scans in the context of touch scans, wherein noise levels may be used for weighting touch data for different tone frequencies with the touch data computed from the same cycle's touch scan measurement data.

FIG. 9C illustrates a new approach for noise scans in the context of touch scans, wherein merged noise levels may be computed from noise scans before and after a touch scan for weighting touch data for different tone frequencies computed from the encapsulated touch scan's measurement data.

FIG. 9D illustrates a new approach for noise scans in the context of touch scans, wherein noise levels may be used for weighting touch data for different tone frequencies with the touch data computed from preceding (new) or subsequent partial touch scan's measurement data. Alternatively, noise levels may be combined and used for touch scan data of an entire scan cycle.

FIG. 9E illustrates a new approach for noise scans in the context of touch scans, wherein touch scan measurement data may be used without an explicit noise scan. Demodulated and low-pass filtered touch scan measurement data is affected by finger presence in multiple ways. First, the mere finger presence changes the touch sensors capacitance network, and second, noise coupling intensity is changing. When demodulating the measurement data with phase information, for example, doing I/Q demodulation, then the mere finger presence typically affects the demodulated phasor in one direction, while noise with phase independent of the drive signal can affect the phasor in any direction. Thus, evaluating the phasor change direction orthogonal to the one affected by finger presence gives a noise measure independent of the noise-free finger presence.

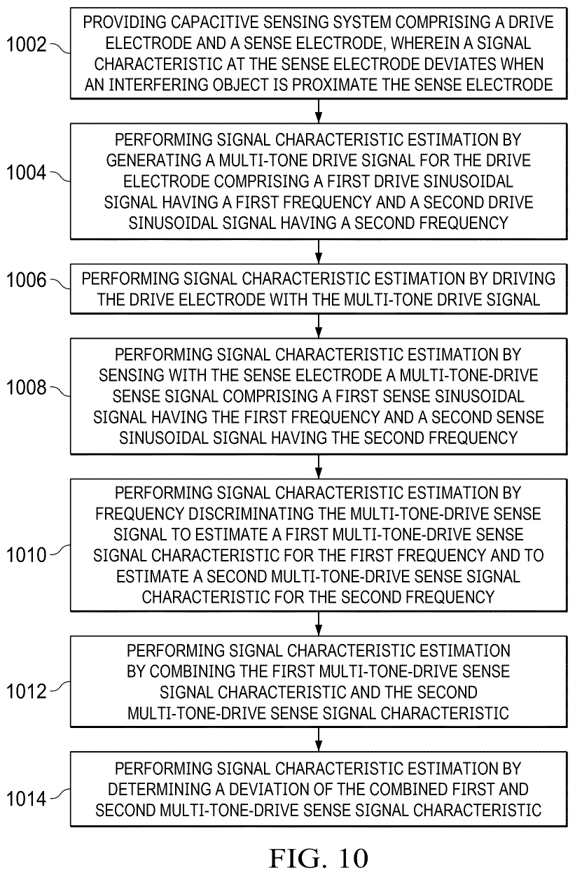

FIG. 10 shows a method for operating a capacitive touch sensing system with multiple carriers simultaneously and makes a “best carrier” decision afterwards, while preserving SNR as for a single-carrier case. A capacitive sensing system is provided 1002 comprising a drive electrode and a sense electrode, wherein a signal characteristic at the sense electrode deviates when an interfering object is proximate the sense electrode. A signal characteristic estimation is performed by generating 1004 a multi-tone drive signal for the drive electrode comprising a first drive sinusoidal signal having a first frequency and a second drive sinusoidal signal having a second frequency. A signal characteristic estimation is performed by driving 1006 the drive electrode with the multi-tone drive signal. A signal characteristic estimation is performed by sensing 1008 with the sense electrode a multi-tone-drive sense signal comprising a first sense sinusoidal signal having the first frequency and a second sense sinusoidal signal having the second frequency. A signal characteristic estimation is performed by frequency discriminating 1010 the multi-tone-drive sense signal to estimate a first multi-tone-drive sense signal characteristic for the first frequency and to estimate a second multi-tone-drive sense signal characteristic for the second frequency. A signal characteristic estimation is performed by combining 1012 the first multi-tone-drive sense signal characteristic and the second multi-tone-drive sense signal characteristic. A signal characteristic estimation is performed by determining 1014 a deviation of the combined first and second multi-tone-drive sense signal characteristic.

Although examples have been described above, other variations and examples may be made from this disclosure without departing from the spirit and scope of these disclosed examples.

1. A method comprising:
providing a capacitive sensing system comprising a drive electrode and a sense electrode, wherein a signal characteristic at the sense electrode deviates when an interfering object is proximate the sense electrode; and
performing signal characteristic estimation by:
generating a multi-tone drive signal for the drive electrode comprising a first drive sinusoidal signal having a first frequency and a second drive sinusoidal signal having a second frequency;
driving the drive electrode with the multi-tone drive signal;
sensing with the sense electrode a multi-tone-drive sense signal,
frequency discriminating the multi-tone-drive sense signal to estimate a first multi-tone-drive sense signal characteristic for the first frequency and to estimate a second multi-tone-drive sense signal characteristic for the second frequency;
combining the first multi-tone-drive sense signal characteristic and the second multi-tone-drive sense signal characteristic; and
determining a deviation of the combined first and second multi-tone-drive sense signal characteristic.

2. The method of claim 1, comprising acquiring qualities for the first and second frequencies by:
driving the drive electrode with a constant drive signal;
sensing with the sense electrode a constant-drive sense signal;
frequency discriminating the constant-drive sense signal to estimate a first constant-drive signal characteristic for the first frequency and to estimate a second constant-drive signal characteristic for the second frequency; and
estimating from the first constant-drive signal characteristic a first quality for the first frequency and estimating from the second constant-drive signal characteristic a second quality for the second frequency.

3. The method of claim 1, wherein the drive electrode and the sense electrode are the same electrode.

4. The method of claim 1, comprising providing a capacitive sensing system comprising a plurality of drive electrodes and the sense electrode positioned to have mutual capacitances between respective ones of the drive electrodes and the sense electrode at nodes, wherein a signal characteristic at the sense electrode deviates when an interfering object is proximate.

5. The method of claim 1, wherein combining the first and second multi-tone-drive sense signal characteristics comprises: equal-gain combining, selection combining, or weighted least squares combining.

6. The method of claim 1, wherein the first multi-tone-drive sense signal characteristic for the first frequency is a first amplitude, the second multi-tone-drive sense signal characteristic for the second frequency is a second amplitude, and wherein first and second amplitudes are within 5% of each other.

7. The method of claim 1, wherein the first and second drive sinusoidal signals have amplitudes within 10% of a largest amplitude of the first and second drive sinusoidal signals.

8. The method of claim 1,
wherein generating the multi-tone drive signal is for respective ones of a plurality of drive electrodes; and
driving the drive electrode with the multi-tone drive signal comprises driving respective ones of the plurality of drive electrodes at different start phases for respective ones of the drive electrodes.

9. The method of claim 1,
wherein the multi-tone drive signal comprises a third drive sinusoidal signal having a third frequency,
wherein the first drive sinusoidal signal has the first frequency and a first start phase,
wherein the second drive sinusoidal signal has the second frequency that is two times the first frequency and a second start phase in phase with the first start phase or shifted by pi radian relative to the first start phase, and
wherein the third drive sinusoidal signal has a third frequency that is three times the first frequency and a third start phase that is pi radian out of phase with the first start phase.

10. The method of claim 1, wherein the multi-tone drive signal comprises a rectangular pulse train having a fundamental frequency and at least a third harmonic frequency.

11. The method of claim 1, comprising scanning for noise at a plurality of frequencies prior to generating a multi-tone drive signal.

12. The method of claim 1, comprising:
providing a capacitive sensing system comprising a plurality of sense electrodes positioned to have mutual capacitances between respective ones of a plurality of drive electrodes and respective ones of the sense electrodes at nodes, wherein a mutual capacitance at a node deviates when an interfering object is proximate; and
decoding the multi-tone sense signal for respective ones of the sense electrodes.

13. A system comprising:
a capacitive touch sensing system comprising a drive electrode and a sense electrode, wherein a signal characteristic at the sense electrode deviates when an interfering object is proximate the sense electrode;
a processor; and
a machine readable storage medium storing instructions, which when executed by the processor, cause the system to:
generate a multi-tone drive signal for the drive electrode comprising a first drive sinusoidal signal having a first frequency and a second drive sinusoidal signal having a second frequency;
drive the drive electrode with the multi-tone drive signal;
sense with the sense electrode a multi-tone-drive sense signal comprising a first sense sinusoidal signal having the first frequency and a second sense sinusoidal signal having the second frequency,
frequency discriminate the multi-tone-drive sense signal to estimate a first multi-tone-drive sense signal characteristic for the first frequency and to estimate a second multi-tone-drive sense signal characteristic for the second frequency; and
combine the first multi-tone-drive sense signal characteristic and the second multi-tone-drive sense signal characteristic; and
determine a deviation of the combined first and second multi-tone-drive sense signal characteristic.

14. The system of claim 13, comprising instructions, which when executed by the processor, cause the system to acquire qualities for the first and second frequencies by:
driving the drive electrode with a constant drive signal;
sensing with the sense electrode a constant-drive sense signal;
frequency discriminating the constant-drive sense signal to estimate a first constant-drive signal characteristic for the first frequency and to estimate a second constant-drive signal characteristic for the second frequency; and
estimating from the first constant-drive signal characteristic a first quality for the first frequency and estimating from the second constant-drive signal characteristic a second quality for the second frequency.

15. The system of claim 13, wherein the drive electrode and the sense electrode are the same electrode.

16. The system as in claim 13, wherein the instructions, which when executed by the processor, cause the system to combine the first and second multi-tone-drive sense signal characteristics by equal-gain combining, selection combining, or weighted least squares combining.

17. The system as in claim 13,
wherein the first multi-tone-drive sense signal characteristic for the first frequency is a first amplitude, the second multi-tone-drive sense signal characteristic for the second frequency is a second amplitude, and wherein first and second amplitudes are within 5% of each other;
wherein the multi-tone drive signal comprises a third drive sinusoidal signal having a third frequency,
wherein the first, second, and third drive sinusoidal signals have amplitudes within 10% of a largest amplitude of the first, second, and third drive sinusoidal signals,
wherein the first drive sinusoidal signal has the first frequency and a first start phase,
wherein the second drive sinusoidal signal has the second frequency that is two times the first frequency and a second start phase in phase with the first start phase or shifted by pi radian relative to the first start phase, and
wherein the third drive sinusoidal signal has a third frequency that is three times the first frequency and a third start phase that is pi radian out of phase with the first start phase.

18. The system as in claim 13, wherein the multi-tone drive signal comprises a rectangular pulse train having a fundamental frequency and at least a third harmonic frequency.

19. The system as in claim 13, wherein the instructions, which when executed by the processor, cause the system to: scan for noise at a plurality of frequencies prior to generating a multi-tone drive signal.

20. The system as in claim 13, comprising:
a plurality of drive electrodes; and
a plurality of sense electrodes positioned to have mutual capacitances between respective ones of the drive electrodes and respective ones of the sense electrodes at nodes, wherein mutual capacitances at nodes deviate when an interfering object is proximate, wherein the instructions, which when executed by the processor, cause the system to: decode the multi-tone sense signal for respective ones of the sense electrodes.
